(19) United States
(12) Patent Application Publication
(10) Pub. No.: US 2026/0097335 A1
(43) Pub. Date: Apr. 9, 2026

(54) FILTER ARRANGEMENT FOR CLEANING HYDRAULIC OIL

(71) Applicant: Deere & Company, Moline, IL (US)

(72) Inventors: MANUEL BILLICH, DORNSTADT (DE); MICHAEL MATTHIAS MEID, WAGHAESEL (DE)

(21) Appl. No.: 19/328,344

(22) Filed: Sep. 15, 2025

(30) Foreign Application Priority Data
Oct. 8, 2024 (EP) 24205423.7

(51) Int. Cl. B01D 35/147; B01D 35/02; B01D 35/153

(52) U.S. Cl. CPC B01D 35/1475; B01D 35/02; B01D 35/153; B01D 2201/167

(57) ABSTRACT

A filter arrangement for cleaning hydraulic oil includes an inlet for supplying pressurized hydraulic oil, a filter element which is connected to the inlet for cleaning the supplied hydraulic oil, an outlet for providing the cleaned hydraulic oil via a first supply line which is connected directly to the outlet for operating a first hydraulic consumer group, and a pressure-limiting valve which is connected to the inlet and which is connected at the outlet directly to a second supply line for operating a second hydraulic consumer group, wherein the first and second supply lines communicate with each other via a throttle element.

### CROSS-REFERENCE TO RELATED APPLICATIONS

This application claims priority to European Patent Application No. 24205423.7, filed October 8, 2024, which is hereby incorporated by reference.

### FIELD OF THE DISCLOSURE

The disclosure relates to a filter arrangement for cleaning hydraulic oil.

### BACKGROUND

In order to exclude possible impairments of function and service-life, hydraulic consumers are operated in agricultural and forestry vehicles and in construction vehicles with filtered hydraulic oil. To this end, a filter element which is located in the hydraulic oil flow is provided and is located between a pressure-generating hydraulic pump and the hydraulic consumers which are intended to be supplied.

### SUMMARY

According to an aspect of the present disclosure, a filter arrangement for cleaning hydraulic oil includes an inlet for supplying pressurized hydraulic oil, a filter element which is connected to the inlet for cleaning the supplied hydraulic oil, an outlet for providing the cleaned hydraulic oil via a first supply line which is connected directly to the outlet for operating a first hydraulic consumer group, and a pressure-limiting valve which is connected to the inlet and which is connected at the outlet directly to a second supply line for operating a second hydraulic consumer group, wherein the first and second supply lines communicate with each other via a throttle element.

According to an aspect of the present disclosure, the throttle element simultaneously forms an additional filter element.

According to an aspect of the present disclosure, the throttle element is constructed in at least two pieces, wherein a central tap opens into an additional supply line for operating an additional hydraulic consumer group.

According to an aspect of the present disclosure, the pressure-limiting valve is configured so as to be directly controlled.

According to an aspect of the present disclosure, cleaned hydraulic oil which is discharged from the filter element is supplied to the outlet via a one-way valve.

According to an aspect of the present disclosure, the filter arrangement is structurally integrated in a filter head having a removable filter housing for receiving the filter element which is in the form of an exchangeable filter insert.

The above and other features will become apparent from the following detailed description and accompanying drawings.

### BRIEF DESCRIPTION OF THE DRAWINGS

The filter arrangement according to the disclosure for cleaning hydraulic oil will be explained in more detail below with reference to the appended drawings. Corresponding components or those with comparable function are identified by the same reference signs. In the figures:

FIG. 1 shows a schematic illustration of a first example embodiment of the filter arrangement according to the disclosure for cleaning hydraulic oil;

FIG. 2 shows a schematic illustration of a second example embodiment of the filter arrangement according to the disclosure for cleaning hydraulic oil; and

FIG. 3 shows a construction type, which is integrated in a filter head, of the filter arrangement according to the disclosure, with a removable filter housing for receiving an exchangeable filter insert.

Like reference numerals are used to indicate like elements throughout the several figures.

### DETAILED DESCRIPTION

The embodiments or implementations disclosed in the above drawings and the following detailed description are not intended to be exhaustive or to limit the present disclosure to these embodiments or implementations.

The filter element generally comprises a filter insert which is received in a filter housing and which is in the form of an exchangeable cartridge, and which contains a pleated paper membrane as a filter-active element. Over time, the pores of the paper membrane become clogged so that the pressure difference which decreases at the filter element between an inlet and outlet increases successively. The same applies to the case in which the viscosity of the hydraulic oil is increased in a temperature-related manner (for example, in the case of a cold start under wintry ambient temperatures). Under such conditions, a pressure-limiting valve bridges the filter element even before reaching a critical pressure difference in order to prevent destruction of the filter cartridge and an associated release of the particles which are retained in the paper membrane. In the case of the bridging of the filter element, however, unfiltered hydraulic oil is introduced into the subsequent hydraulic system. At best this can be tolerated for a limited time and is further dependent on the requirements placed on cleanliness of the relevant hydraulic consumers. Depending on the type of hydraulic consumers, in this regard considerable differences may exist.

An object of the present disclosure is therefore to further develop a filter arrangement of the type set out in the introduction so that account is taken of different requirements placed on cleanliness of hydraulic consumers which are operated thereby.

This object is achieved by a filter arrangement for cleaning hydraulic oil having the features of one or more embodiments disclosed herein.

The filter arrangement according to the disclosure for cleaning hydraulic oil comprises an inlet for supplying pressurized hydraulic oil, a filter element which is connected to the inlet for cleaning the supplied hydraulic oil, an outlet for providing the cleaned hydraulic oil via a first supply line which is connected directly to the outlet for operating a first hydraulic consumer group and a pressure-limiting valve which is connected to the inlet and which is connected at the outlet directly to a second supply line for operating a second hydraulic consumer group, wherein the two supply lines communicate with each other via a throttle element.

The filter arrangement is for example a component of a hydraulic system of an agricultural or forestry vehicle or a construction vehicle and is connected via its inlet to a conveying outlet of a hydraulic pump in order to purge a hydraulic volume flow which comes from the hydraulic pump of undesirable particles in the form of abraded parts, impurities introduced from the outer side and the like.

Depending on the actuation state of the pressure-limiting valve, the filter arrangement now has two different operating modes. In a normal operating mode, the pressure-limiting valve is not actuated and takes up a blocked valve position. The entire hydraulic volume flow coming from the hydraulic pump is introduced in this case through the filter element and is subsequently distributed via the two supply lines over the two hydraulic consumer groups. In this case, a specific pressure decrease occurs over the throttle element but can be limited by corresponding specification of the throttle resistance to a level which is acceptable for the operation of the second hydraulic consumer group.

In the event of an agricultural vehicle in the form of a tractor, the first hydraulic consumer group relates to a gear mechanism lubrication or control unit, the second hydraulic consumer group relates to other hydraulic operating devices, such as, for example, a main cylinder pump, hydraulic control devices, pressure-regulating valves, pressure-limiting valves, hydraulic suspension systems, comprising hydraulic cylinders and damping valves, or the like. In such a case, the first hydraulic consumer group generally has with respect to the second hydraulic consumer group higher cleanliness requirements with respect to the supplied hydraulic oil.

If the hydraulic pressure which decreases over the filter element increases because it becomes clogged with separated particles over time with an increase in the flow resistance and/or as a result of a temperature-related increase in the viscosity of the hydraulic oil, the pressure-limiting valve is actuated by bridging the filter element when a predetermined switching threshold which is predetermined in accordance with a pressure difference permitted for the relevant filter element is reached so that it takes up a permeable valve position. In this intermediate operating mode, a majority of the hydraulic volume flow which is supplied via the inlet passes through the pressure-limiting valve and the comparatively smaller portion continues to make its way through the filter element. In this manner, a basic supply of the dirt-sensitive first hydraulic consumer group with filtered hydraulic oil is maintained via the first supply line, wherein the throttle element substantially prevents an overflow of non-filtered hydraulic oil from the second supply line. However, the supply of the comparatively less dirt-sensitive second hydraulic consumer group is carried out in an unlimited manner via the second supply line which is directly connected to the pressure-limiting valve at the outlet. This allows an at least temporary maintenance of the operation of the hydraulic operating devices which are included by the consumer groups, for example, up to exchange of a filter insert which is included by the filter element or up to operation-related heating of the hydraulic oil which results in the viscosity and therefore the pressure difference, which decreases over the filter element, decreasing until the pressure-limiting valve automatically returns to the blocked valve position and therefore to the normal operating mode.

In other words, the filter arrangement has a plurality of supply connections, each of which complies with a different cleanliness requirement of a hydraulic consumer group which is intended to be operated thereon.

Advantageous refinements of the filter arrangement according to the disclosure can be found in one or more embodiments disclosed herein.

Initially, it is possible for the throttle element simultaneously to form an additional filter element. To this end, the throttle element can comprise a filter screen which prevents an overflow of at least relatively coarse particles from the second supply line into the first supply line in the intermediate operating mode. In the normal operating mode, the filter screen is again flushed as a result of the reversal of direction of the hydraulic volume flow which passes through it.

In some embodiments, the throttle element is constructed in at least two pieces, wherein a central tap opens into an additional supply line for operating an additional hydraulic consumer group. Thus, two separate throttle elements which are connected in series between the first and second supply line can be provided. The central tap is located as a branch which opens in the additional supply line between the two throttle elements. This approach can be expanded to any (greater) number of throttle elements. In this instance, the cleanliness of the provided hydraulic oil in the intermediate operating mode increases successively from the first supply line, via the additional ones up to the second supply line.

The actuation of the pressure-limiting valve is generally carried out purely hydraulically and, to this end, it can be configured so as to be directly controlled and can be brought into the permeable valve position in accordance with a hydraulic pressure decrease which occurs between the inlet and outlet side counter to a restoring resilient force.

In order to prevent a backflow of hydraulic oil in the direction of the filter element and an associated back-washing of particles retained therein, it is possible to supply cleaned hydraulic oil which is discharged from the filter element to the outlet via a one-way valve. The one-way valve is a conventional membrane type or non-return ball valve.

It is further conceivable for the filter arrangement to be structurally integrated in a filter head having a removable filter housing for receiving the filter element which is in the form of an exchangeable filter insert. The valve seats which are included by the pressure-limiting valve or one-way valve and the throttle element (or the throttle elements) itself can be formed directly in a housing body of the filter head here. The inlet and the supply lines lead to associated supply connections which are arranged in the form of standardized threaded holes at an outer side of the filter head.

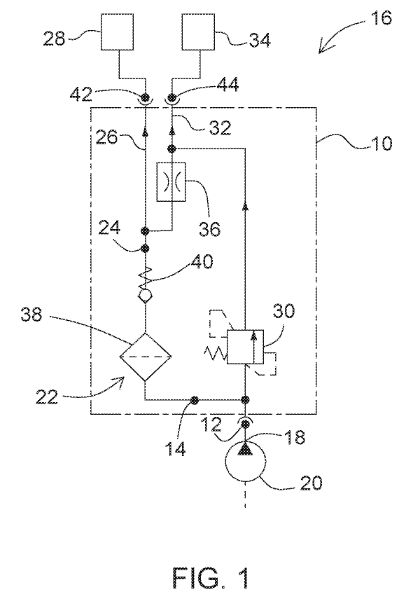

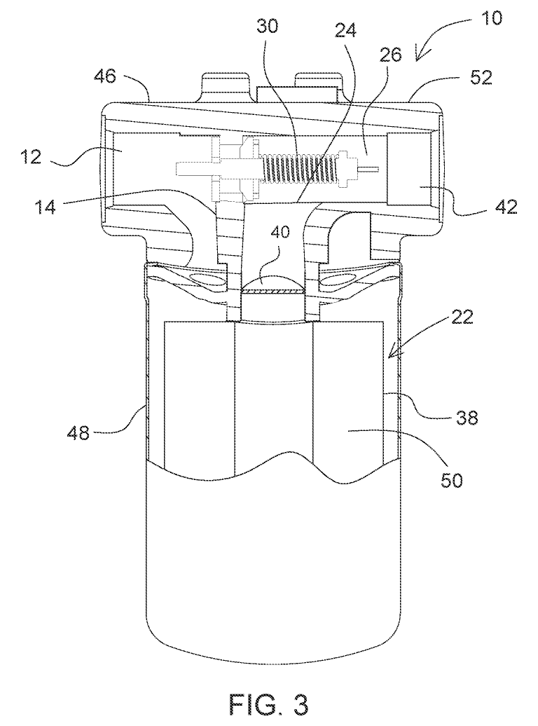

FIG. 1 shows a schematic illustration of a first example embodiment of the filter arrangement 10 according to the disclosure for cleaning hydraulic oil, wherein it is intended to be described with reference to the construction type illustrated by way of example in FIG. 3.

Accordingly, the filter arrangement 10 comprises an inlet 14 which communicates with a supply connection 12 at the inlet for supplying pressurized hydraulic oil. The filter arrangement 10 is here a component of a hydraulic system 16 of an agricultural or forestry vehicle (not shown) and connected via its inlet 14 to a conveying outlet 18 of a hydraulic pump 20 in order to purge a hydraulic volume flow, which comes from the hydraulic pump 20, of undesirable particles in the form of abraded parts, impurities introduced from the outer side and the like.

The actual cleaning of the supplied hydraulic oil is carried out by means of a filter element 22 which is connected to the inlet 14, wherein the cleaned hydraulic oil is provided via an outlet 24 of a first supply line 26 which is connected directly thereto for operating a first hydraulic consumer group 28.

A pressure-limiting valve 30 which is connected to the inlet 14 is connected directly at the outlet to a second supply line 32 for operating a second hydraulic consumer group 34, wherein the two supply lines 26, 32 communicate with each other via a throttle element 36.

Depending on the actuation state of the pressure-limiting valve 30, the filter arrangement 10 now has two different operating modes.

In a normal operating made, the pressure-limiting valve 30 is not actuated and takes up a blocked valve position (in accordance with the illustration in FIG. 1). The entire hydraulic volume flow is then introduced through the filter element 22 and is subsequently distributed via the two supply lines 26, 32 over the two hydraulic consumer groups 28, 34. In this case, a specific pressure decrease occurs over the throttle element 36. It is limited to a level which is acceptable for operating the second hydraulic consumer group 34 by correspondingly specifying the throttle resistance.

In the case of an agricultural vehicle in the form of a tractor, the first hydraulic consumer group 28 relates to a gear mechanism lubrication or control unit, the second hydraulic consumer group 34 relates to other hydraulic operating devices, such as, for example, a main hydraulic pump, hydraulic control devices, pressure-regulating valves, pressure-limiting valves, hydraulic suspension systems, comprising hydraulic cylinders and damping valves, or the like. In such a case, the first hydraulic consumer group 28 generally has with respect to the second hydraulic consumer group 34 higher cleanliness requirements with respect to the supplied hydraulic oil.

If the hydraulic pressure which decreases over the filter element 22 increases, whether because it becomes clogged over time with separated particles with an increase in the flow resistance, and/or as a result of a temperature-related increase of the viscosity of the hydraulic oil, the pressure-limiting valve 30 is actuated with bridging of the filter element 22, when a predetermined switching threshold which is predetermined in accordance with a pressure difference which is permitted for the relevant filter element 22 is reached, so that it takes up a permeable valve position. In this intermediate operating mode, a majority of the hydraulic volume flow which is supplied via the inlet 14 passes through the pressure-limiting valve 30, the comparatively smaller portion continues to make its way through the filter element 22. As a result, a basic supply of the dirt-sensitive first hydraulic consumer group 28 is maintained with filtered hydraulic oil via the first supply line 26, wherein the throttle element 36 substantially prevents an overflow of non-filtered hydraulic oil from the second supply line 32. However, the supply of the comparatively less dirt-sensitive second hydraulic consumer group 34 is carried out in a non-limited manner via the second supply line 32 which is directly connected to the pressure-limiting valve 30 at the outlet. This allows an at least temporary maintenance of the operation of the hydraulic operating devices which are included by the consumer groups 28, 34, for example, until a filter insert 38 which is included by the filter element 22 is exchanged, or until an operation-related heating of the hydraulic oil which leads to the viscosity and therefore the pressure difference which decreases over the filter element 22 decreasing until the pressure-limiting valve 30 automatically returns to the blocked valve position and therefore to the normal operating mode.

In an optional configuration of the filter arrangement 10, the throttle element 36 at the same time forms an additional filter element. To this end, the throttle element 36 comprises a filter screen which prevents an overflow of at least relatively coarse particles from the second supply line 32 into the first supply line 26 in the intermediate operating mode. In the normal operating mode, the filter screen is again flushed as a result of the reversal of direction of the hydraulic volume flow which passes through it.

The actuation of the pressure-limiting valve 30 is carried out purely hydraulically, wherein it is configured so as to be directly controlled and is brought into the permeable valve position in accordance with a hydraulic pressure decrease which occurs between the inlet and outlet side counter to a restoring resilient force.

In order to prevent a backflow of hydraulic oil in the direction of the filter element 22 and an associated back-washing of particles retained therein, cleaned hydraulic oil which is discharged from the filter element 22 is supplied to the outlet 24 via a one-way valve 40. The one-way valve 40 is a conventional membrane type or non-return ball valve.

In other words, the supply lines 26, 32 lead to a plurality of or associated supply connections 42, 44 at the outlet on the filter arrangement 10, each of which complies with a different cleanliness requirement of a hydraulic consumer group 28, 34 which is intended to be operated thereon.

According to the example construction type which is reproduced in FIG. 3, the filter arrangement 10 is structurally integrated in a filter head 46 having a removable filter housing 48 for receiving the filter insert 38, wherein the filter insert 38 contains a pleated paper membrane 50 as a filter-active element. The valve seats which are included by the pressure-limiting valve 30 or one-way valve 40 and the throttle element 36 itself are directly formed in a housing body 52 of the filter head 46. The housing body 52 comprises, for example, aluminium (aluminum) or zinc die-casting. The throttle element 36 may be in the form of a casting channel therein.

As can further be seen in FIG. 3, the supply connections 12, 42, 44 at the inlet and outlet (the supply connection 44 at the outlet cannot be seen in the selected sectioned illustration) are arranged in the form of standardized threaded holes at an outer side of the filter head 46. In this instance, it may be noted that, for reasons of clarity, FIG. 3 does not illustrate all the components of the filter arrangement 10.

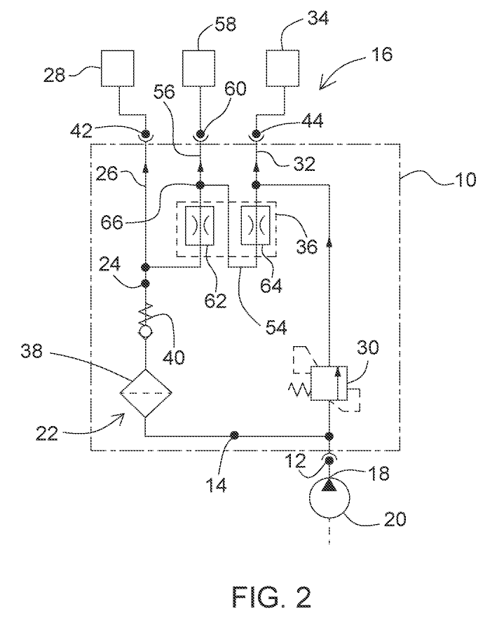

FIG. 2 shows a second example embodiment of the filter arrangement 10 according to the disclosure. It differs from the first example embodiment which is depicted in FIG. 1 in that the throttle element 36 is constructed in two pieces, wherein a central tap 54 opens in an additional supply line 56 for operating an additional hydraulic consumer group 58 at an additional supply connection 60. More specifically, a functional or structural separation into two separate throttle elements 62, 64 which are connected in series between the first and second supply lines 26, 32 is carried out. The central tap 54 is located between the two throttle elements 62, 64 as a branch 66 which opens in the additional supply line 56.

This approach can be expanded to any (greater) number of throttle elements. In this instance, the cleanliness of the provided hydraulic oil in the intermediate operating mode increases successively from the first supply line 26, via the additional supply line(s) up to the second supply line 32.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A filter arrangement for cleaning hydraulic oil, comprising:
an inlet for supplying pressurized hydraulic oil;
a filter element which is connected to the inlet for cleaning the supplied hydraulic oil;
an outlet for providing the cleaned hydraulic oil via a first supply line which is connected directly to the outlet for operating a first hydraulic consumer group; and
a pressure-limiting valve which is connected to the inlet and which is connected at the outlet directly to a second supply line for operating a second hydraulic consumer group, wherein the first and second supply lines communicate with each other via a throttle element.

2. The filter arrangement of claim 1, wherein the throttle element simultaneously forms an additional filter element.

3. The filter arrangement of claim 1, wherein the throttle element is constructed in at least two pieces, wherein a central tap opens into an additional supply line for operating an additional hydraulic consumer group.

4. The filter arrangement of claim 1, wherein the pressure-limiting valve is configured so as to be directly controlled.

5. The filter arrangement of claim 1, wherein cleaned hydraulic oil which is discharged from the filter element is supplied to the outlet via a one-way valve.

6. The filter arrangement of claim 1, wherein the filter arrangement is structurally integrated in a filter head having a removable filter housing for receiving the filter element which is in the form of an exchangeable filter insert.

7. A filter arrangement for cleaning hydraulic oil, comprising:
an inlet for supplying pressurized hydraulic oil;
a filter element which is connected to the inlet for cleaning the supplied hydraulic oil;
an outlet for providing the cleaned hydraulic oil via a first supply line which is connected directly to the outlet for operating a first hydraulic consumer group; and
a pressure-limiting valve which is connected to the inlet and which is connected at the outlet directly to a second supply line for operating a second hydraulic consumer group, wherein the first and second supply lines communicate with each other via a throttle element, which simultaneously forms an additional filter element, and wherein cleaned hydraulic oil which is discharged from the filter element is supplied to the outlet via a one-way valve.

8. The filter arrangement of claim 7, wherein the filter arrangement is structurally integrated in a filter head having a removable filter housing for receiving the filter element which is in the form of an exchangeable filter insert.
